(19) United States
(12) Patent Application Publication
(10) Pub. No.: US 2020/0290753 A1
(43) Pub. Date: Sep. 17, 2020

(54) METHOD AND DEVICE FOR DOCKING AN UNMANNED AERIAL VEHICLE WITH A MOVEABLE DOCKING STATION

(71) Applicant: HEROTECH8 LTD, Cranfield Bedfordshire (GB)

(72) Inventors: Edward David Nicholas ANASTASSACOS, Bedford, Bedfordshire (GB); Robin Francois Humbert GOJON, Bedford, Bedfordshire (GB); Ciaran Michael S. MCMASTER, Clyde (GB)

(21) Appl. No.: 16/640,225

(22) PCT Filed: Aug. 21, 2018
(86) PCT No.: PCT/GB2018/052372

§ 371 Date: Feb. 19, 2020

(30) Foreign Application Priority Data
Aug. 21, 2017 (GB) 1713415.6

(51) Int. Cl. B64F 1/36; B64C 39/02; B64F 1/18; B64F 1/32; B60L 53/36; B60L 53/66

(52) U.S. Cl. CPC B64F 1/364; B64C 39/024; B64F 1/18; B64F 1/32; B60L 2200/10; B60L 53/66; B64C 2201/027; B64C 2201/182; B60L 53/36

(57) ABSTRACT

A device for docking an unmanned vehicle with a moveable docking station is provided, the device comprising: an interface surface configured to cooperatively engage a counterpart interface surface of a counterpart device; at least one identifying means arranged to be detected by a counterpart device; and at least one sensor configured to detect an at least one identifying means of a counterpart device. Also provided is a method of docking an unmanned vehicle with a moveable docking station, the method comprising: performing a cooperative docking procedure; wherein the cooperative docking procedure comprises each of the unmanned vehicle and docking station capturing the attitude and/or position of the other and, responsive to the captured attitude and/or position, adjusting the respective attitude and/or position of the unmanned vehicle and docking station to a mutually cooperative docking configuration so as to provide docking of the unmanned vehicle with the docking station.

### FIELD

The present invention relates to a device for docking an unmanned vehicle with a docking station and a method of docking an unmanned vehicle. In particular, but not exclusively, one or more embodiments of the present invention may relate to docking an unmanned aerial vehicle with a movable docking station.

### BACKGROUND

Unmanned Aerial Vehicles (UAVs), commonly referred to as “drones”, are becoming increasingly popular for many applications. These vehicles do not have a human pilot aboard and have varying degrees of autonomy. Some may be remotely controlled by a human operator, whereas others may operate autonomously, being controlled by on-board computers. UAVs are generally used for tasks which are too monotonous, dangerous or expensive for a human to perform.

Many commercial off-the-shelf UAVs are based on a multi-rotor design which allows for stable take-off, flight and landing. Consequently, this makes such drones increasingly attractive for a variety of uses including surveillance, aerial photography, search and rescue, geographic mapping, storm tracking and recreational use. Another possible application for UAVs is the delivery of small goods and this application is attracting significant commercial interest.

The increased use of UAVs will necessitate increased automation. A key function of a UAV is the ability for it to takeoff and land safely without damaging itself or its payload. The UAV is at significant risk during these procedures. For example, a gust of wind could blow the

UAV off course or into a nearby obstacle resulting in an unsuccessful landing or damage to the UAV. Furthermore, there is an increasing need to launch UAVs from moving vehicles or vessels, for example, trucks, vans, boats and ships, In these circumstances, the landing platform for the UAV is itself moving which increases the complexity of the landing procedure,

Other important tasks which need to be performed include refuelling or recharging the UAV, exchanging payloads, diagnosing faults and carrying out maintenance.

Aspects and embodiments of the invention were devised with the foregoing in mind.

### SUMMARY OF THE INVENTION

According to a first aspect of the present invention, there is provided a device for docking an unmanned vehicle with a moveable docking station, the device comprising: an interface surface configured to cooperatively engage a counterpart interface surface of a counterpart device; at least identifying means arranged to be detected by a counterpart device; and at least sensor configured to detect at least identifying means of a counterpart device.

By “movable”, it shall be understood that the docking station is capable of manual or automatic movement, such as movement in any of the x, y, or z plane, pitching rolling or yawing, or any combination thereof.

By “cooperatively engage”, it shall be understood that the interface surface or a portion thereof is configured to have a complementary geometry to a counterpart interface surface or a portion thereof of a counterpart device. As such, the geometry of the interface surface or a portion thereof may be configured to fit against a corresponding counterpart surface or portion thereof of the counterpart device such that the two surfaces may conform and/or interlock.

The identifying means may be any feature, component or device which enables the device according to the first aspect to be recognised as such. This includes, but is not limited to, visual markers and signal emitters. For example, the identifying means may be selected from one or more of an LED, a printed marker such as a Quick Response (QR) code, an Aruco marker or a barcode, an electromagnetic wave emitter such as a radiowave emitter, near field emitter or an infrared emitter, Bluetooth signal transmitter, WiFi transmitter, laser emitter, cellular signal transmitter, speaker, GPS signal emitter, ultrasonic transmitter, virtual wideband source or the like.

The sensor may be any device capable of recognising the identifying means. For example the sensor may be a camera, IR camera, radar, electromagnetic sensor, Bluetooth receiver, GPS receiver, WiFi receiver, cellular signal receiver, microphone, or the like.

The device may comprise a sensor for detecting the attitude of the device. This may be the same sensor as the sensor configured to detect the identifying means or at least one further sensor. Optionally, the sensor may be an inertial measurement unit.

In some embodiments, the device interface surface and/or the counterpart interface surface has a male connector configuration.

In some embodiments, at least a portion of the device interface surface and/or the counterpart interface surface may have a convex surface. Optionally, the whole of the interface surface may be convex.

In some embodiments, the device interface surface and/or the counterpart interface surface may have a female connector configuration.

In some embodiments, at least a portion of the device interface surface and/or the counterpart interface surface may have a concave surface. Optionally, the whole of the interface surface may be concave.

The provision of such male and/or female connectors, and/or concave and/or convex surfaces, may enable cooperative engagement between the interface surface of the device or a portion thereof and a counterpart interface surface or a portion thereof of the counterpart device.

In some embodiments, the identifying means may comprise at least one visual marker. Optionally the visual marker may be selected from one or more of the following:
an LED;
a Quick Response (QR) code;
an Aruco marker:
a bar code; and
an infrared emitter.

In some embodiments, the at least one sensor may comprise a camera.

Optionally, the camera is an infrared camera.

In some embodiments, the device may comprise a plurality of visual markers and/or identifying signal emitters.

Optionally, the device may comprise three visual markers and/or identifying signal emitters arranged in a triangular configuration.

The device may comprise a plurality of sensors. The plurality of sensors may be of the same sort or of different sorts. For example, the device may comprise a plurality of image sensors.

Optionally, the device may further comprise a coupling to hold the unmanned vehicle in position on the docking station once docking has been achieved. The coupling may be electromechanical or the coupling may be magnetic. For example, the coupling may be electromagnetic, permanently magnetic or semi-permanently magnetic. Optionally the coupling may be battery powered.

Such a coupling may aid in aligning the unmanned vehicle with the device in order than one or more other connectors may be accurately positioned. Accordingly, the device may comprise one or more connectors. The connectors may be suitable for performing one or more of the following: refuelling or recharging the unmanned vehicle; powering the unmanned vehicle; and transferring data between the unmanned vehicle and the docking station.

Optionally, the device may further comprise a transmitter and a receiver for communicating with a counterpart device.

According to a second aspect of the present invention, there is provided a method of docking an unmanned vehicle with a moveable docking station, the method comprising: performing a cooperative docking procedure; and wherein the cooperative docking procedure comprises each of the unmanned vehicle and docking station capturing the attitude and/or position of the other and responsive to the captured attitude and/or position adjusting the respective attitude and/or position of the unmanned vehicle and docking station to a mutually cooperative docking configuration so as to provide docking of the unmanned vehicle with the docking station.

According to a third aspect of the present invention, there is provided a method of docking an unmanned vehicle with a device according to the first aspect of the present invention, the method comprising: performing a cooperative docking procedure; and wherein the cooperative docking procedure comprises each of the unmanned vehicle and device according to the first aspect of the present invention capturing the attitude and/or position of the other and responsive to the captured attitude and/or position adjusting the respective attitude and/or position of the unmanned vehicle and device according to the first aspect of the present invention to a mutually cooperative docking configuration so as to provide docking of the unmanned vehicle with the device according to the first aspect of the present invention.

With regard to each of the second and third aspects of the present invention, capturing the attitude and/or position may comprise at least one of the unmanned vehicle and docking station identifying at least one visual marker located on the other or receiving at least one identifying signal from the other and, responsive to the location of the at least one visual marker or to the identifying signal, calculating a relative position between the unmanned vehicle and docking station.

Optionally, capturing the attitude and/or position may comprise at least one of the unmanned vehicle and docking station receiving an identifying signal from the other and determining its attitude based on the identifying signal.

The identifying signal may enable at least one aspect of a position or attitude of the component from which the signal is emitted to be determined.

The signal may be from any sensor or emitter. For example, the identifying signal may be from at least one inertial measurement unit. The identifying signal may also be an ultrasonic signal, an electromagnetic wave signal, such as a radio wave/RFID signal, infrared signal or near field communication signal, a laser signal, a GPS signal, a sound wave, a WiFi signal, a Bluetooth signal, a cellular signal or the like. However, the skilled person would understand that these lists are non-exhaustive and that any emitted signal or series of signals that allow an aspect of the position or attitude to be determined may be used.

Optionally, capturing the attitude and/or position comprises the docking station identifying at least one visual marker on the unmanned vehicle, or the docking station receiving at least one identifying signal from the unmanned vehicle, and, responsive to the location of the at least one visual marker or to the identifying signal, calculating a relative position between the unmanned vehicle and docking station and determining an attitude.

For example, the unmanned vehicle may have a visual marker or identifying signal emitter which may be located or received by a camera or receiver on the docking station and used to calculate a route between the unmanned vehicle and the docking station and determining an attitude.

Adjusting the respective attitude and/or position of the unmanned vehicle and docking station may comprise: each of the unmanned vehicle and docking station calculating a respective vector in which to move themselves to reduce the relative position between the unmanned vehicle and docking station; and sending an actuation signal to at least one actuator of each of the unmanned vehicle and docking station respectively to move the unmanned vehicle and docking station along their respective calculated vectors to reduce the relative position between the unmanned vehicle and docking station.

Optionally, adjusting the respective attitude and/or position of the unmanned vehicle and docking station may comprise: each of the unmanned vehicle and docking station calculating a manoeuvre based on the identifying signal to move themselves to a mutually corresponding attitude; and sending an actuation signal to at least one actuator of each of the unmanned vehicle and docking station respectively to perform the calculated manoeuvre to move themselves into the mutually corresponding attitude.

Optionally, the calculated manoeuvres may be selected from a pitch, roll, yaw or combination thereof.

Optionally, the identifying signal may be from at least one inertial measurement unit.

The mutually corresponding attitude may comprise a horizontal attitude.

Optionally, identifying at least one visual marker or identifying signal may comprise capturing an image or location of the at least one visual marker or identifying signal.

Adjusting the respective attitude and/or position of the unmanned vehicle and docking station may comprise: each of the unmanned vehicle and docking station calculating a respective vector in which to move themselves to move the at least one visual marker or identifying signal towards the centre of the image or captured location; and sending an actuation signal to at least one actuator of each of the unmanned vehicle and docking station respectively to move the unmanned vehicle and docking station along their respective calculated vectors to move the at least one visual marker or identifying signal towards the centre of the image or captured location.

Optionally, adjusting the respective attitude and/or position of the unmanned vehicle and docking station may comprise performing a manoeuvre such that the at least one visual marker is captured in the image in a certain orientation.

Capturing the attitude and/or position of the other may be performed as part of an iterative loop.

Optionally, the iterative loop may iterate 200 times per second.

The method of docking an unmanned vehicle may comprise identifying an available docking station, approaching the available docking station, sending a docking request; and receiving a signal from an available docking station,

Optionally, the method may further comprise engaging a coupling to hold the unmanned vehicle in position on the docking station once docking has been achieved.

The method may further comprise: determining when the unmanned vehicle and docking station are within a threshold proximity range and a threshold relative position range of each other such that docking can be successfully achieved; and engaging the coupling to complete the cooperative docking procedure.

Optionally, the method may further comprise performing a task selected from one or more of the following once the unmanned vehicle has docked with the docking station: refuelling or recharging the unmanned vehicle; transferring data between the unmanned vehicle and the docking station; diagnosing mechanical or electrical faults; carrying out maintenance on the unmanned vehicle; retrieving a payload which has been carried by the unmanned vehicle; and loading a new payload onto the unmanned vehicle.

According to a forth aspect of the present invention, there is provided a kit of parts comprising two or more of the devices described above.

According to a fifth aspect of the present invention, there is provided an unmanned vehicle comprising a device as described above.

Optionally, the unmanned vehicle may comprise an unmanned aerial vehicle.

According to a sixth aspect of the present invention, there is provided a moveable docking station comprising a device described above,

Optionally, the moveable docking station may comprise a robotic arm having an end effector, wherein the end effector comprises a device as described above.

According to a seventh aspect of the present invention, there is provided a system comprising an unmanned vehicle and a moveable docking station as described above.

### BRIEF DESCRIPTION OF THE DRAWINGS

One or more specific embodiments in accordance with aspects of the present invention will be described, by way of example only, and with reference to the following drawings in which:

FIG. 1 is a schematic view of an unmanned aerial vehicle in accordance with an embodiment of the present invention.

FIG. 2a is a view through an image sensor of the unmanned aerial vehicle of FIG. 1.

FIG. 2b is a flow control diagram for the unmanned aerial vehicle FIG. 1.

FIGS. 3a to 3c shows a progression of views through an image sensor of the unmanned air vehicle FIG. 1.

FIG. 4 is a schematic view of a moveable docking station in accordance with an embodiment of the present invention.

FIG. 5a is a view through an image sensor of the docking station of FIG. 4.

FIG. 5b is a flow control diagram for the docking station of FIG. 4.

FIGS. 5c to 5e shows a progression of views through an image sensor of the docking station of FIG. 4.

FIG. 6 is a perspective view of a system comprising an unmanned aerial vehicle and a moveable docking station in accordance with an embodiment of the present invention.

FIG. 7a is a perspective view of an interface device in accordance with an embodiment of the present invention.

FIG. 7b is a perspective view of a complementary interface device in accordance with an embodiment of the present invention for coupling with the interface device of FIG. 7a.

FIG. 8 shows the interface device and complementary interface device of FIGS. 7a and 7b respectively.

FIGS. 9a and 9b are views of images obtained by an image sensor of a device in accordance with an embodiment of the present invention.

FIGS. 10a and 10b are further views of images obtained by an image sensor of a device in accordance with an embodiment of the present invention.

FIGS. 11a and 11b are schematic views of an unmanned aerial vehicle and a moveable docking station in accordance with embodiments of the present invention engaging in a cooperative docking procedure

### DETAILED DESCRIPTION

A description of examples in accordance with the disclosure will now be provided with reference to the drawings and in which like reference numerals refer to like parts.

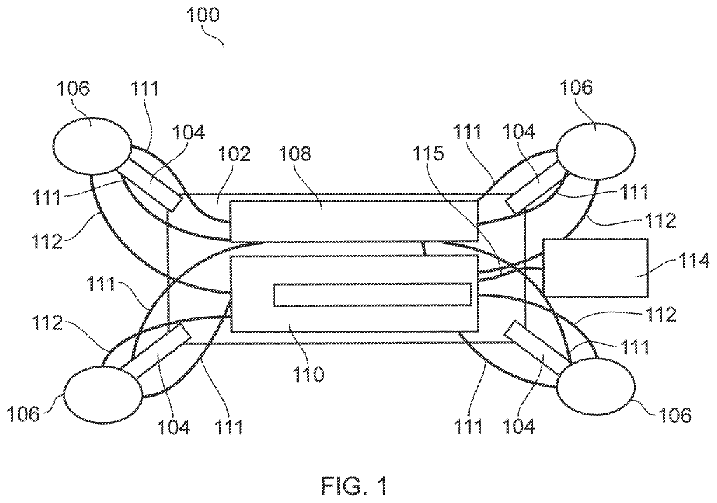

In the first example of the disclosure illustrated in FIG. 1, an unmanned vehicle 100 for cooperatively docking to with a moveable docking station comprises central plate 102, which is connected to motors 106 by arms 104. The motors 106 are powered by power source 108 through wires 111 and wires 112 are connected to the controller 110. The speed of each motor 106 is proportional to the voltage on each wire 112. The controller 110 comprises a USB which is able to connect to USB camera 114 with USB cable 115.

The moveable docking station shall be understood to be a docking station which may be manipulated to alter its position, attitude and/or orientation, Such manipulation may be by any means, and may be autonomous or manually controlled or any combination thereof. Optionally, manual control may be by an extraneous controller or signal. Optionally, autonomous control may be in response to an observed visual marker signal or received signal. In some options an extraneous controller or signal may trigger a manipulation of the docking station, whereby the precise manipulation is then autonomously controlled. Movement may be achieved by the provision of one or more actuators. For example, movement may be achieved by the provision of robotic arm actuation, CNC-driven actuation, vehicle-driven actuation or the like.

Preferably, the movement may have multiple degrees of freedom. For example the manipulation may have three degrees of freedom, or more than three degrees of freedom. The degrees of freedom may include any combination of pitch, roll, yaw and movement in the X, Y and/or Z planes.

The controller 110 may be a desktop running an operating system similar to windows tailored for applications with unmanned vehicles. The instructions are provided to the motors 106 by controller 110. The inputs of the controller 110 may be the information captured by the camera 114 and the outputs of the controller 110 are the speeds of the motors 106. The control of the speeds of motors 106 will change the position and relative position to allow the unmanned vehicle to change its pitch, roll, and yaw (referred to as attitude hereinafter).

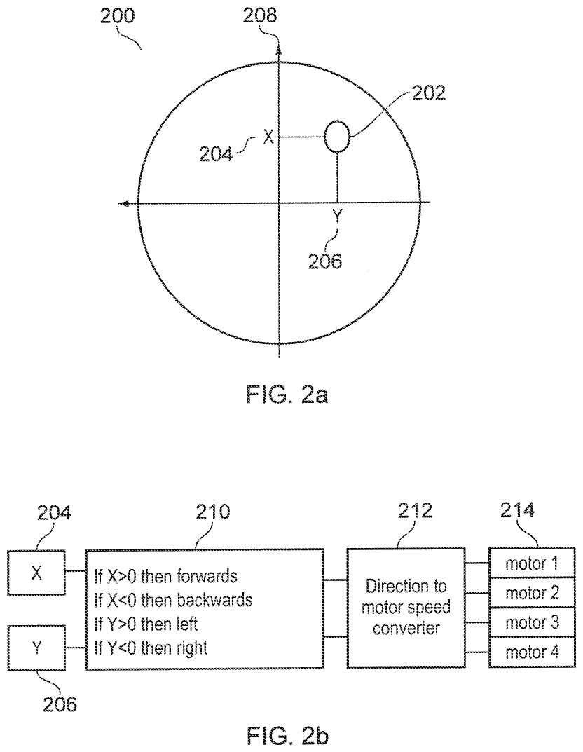

In the first example of this disclosure illustrated in FIG. 2a an illustrative schematic of the frame 200 captured by the camera 114 as shown in FIG. 1 is described. The frame 200 comprises visual marker 202 which is present on the moveable docking station (not shown), and a relative coordinate system 208 by which the position of visual marker 202 is measured. In this example the position of the visual marker 202 is measured as X and Y coordinates (204 and 206 respectively),

FIG. 2b is an illustrative flow diagram of the controller 110 algorithm which runs at a frequency 200 Hz. However, the skilled person will appreciate that other frequencies can be used. The controller 110 converts the measured X and Y positions (204 and 206 respectively) of the visual marker 202 into a desired direction 210 for the unmanned vehicle 100 to position itself. The desired direction 210 is then converted 212 into motor 106 speed 214. The change in motor 106 speed 214 will change the attitude of the unmanned vehicle 100.

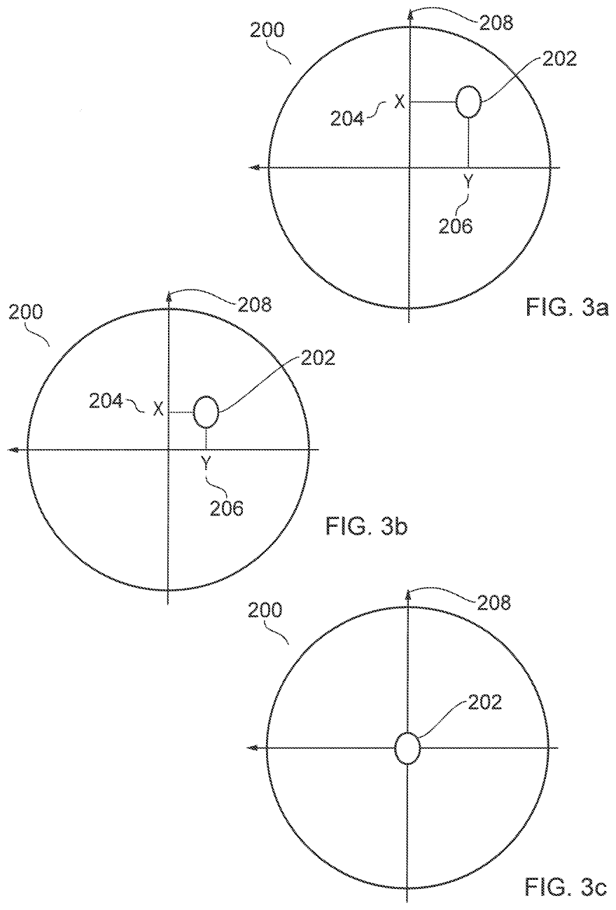

An illustrative example of frames 200 captured by camera 114 measures responsive to the instructions provided by the controller 110 to motors 106 is shown in FIGS. 3a-c. The initial position of the unmanned vehicle 100 is such that the visual marker 202 situated on the moveable docking station is not centred on the coordinate system 208 in frame 200 taken by camera 114. This can be seen by X and Y coordinates (204 and 206 respectively). The controller 110 subsequently converts the measured X and Y positions (204 and 206 respectively) of the visual marker 202 into a desired direction 210 for the unmanned vehicle 100 to position itself. The desired direction 210 is then converted 212 into motor 106 speed 214. The change in motor 106 speed 214 will change the attitude of the unmanned vehicle 100.

The camera 114 then subsequently captures another frame 200 which depicts the second position of the unmanned vehicle 100 after the initial instructions provided by controller 110, which is shown in FIG. 3b. The position of the unmanned vehicle 100 is such that the visual marker 202 situated on the moveable docking station is not centred on the coordinate system 208 in frame 200 taken by camera 114. However, the magnitude of the displacement from the centre of the coordinate system 208 is reduced. The controller 110 subsequently converts the measured X and Y positions (204 and 206 respectively) of the visual marker 202 into a desired direction 210 for the unmanned vehicle 100 to position itself. The desired direction 210 is then converted 212 into motor 106 speed 214. The change in motor 106 speed 214 will change the attitude of the unmanned vehicle 100.

The final frame 200 which is captured by camera 114 as shown in FIG. 3c shows the visual marker 202 at the centre of coordinate system 208. The described sequence occurs at a frequency of 200 Hz and if at any time the X or Y position (204 and 206 respectively) of visual marker 202 deviates from the centre of the coordinate system 208 controller 110 will change the speed 214 of motors 106 so as to re-centre onto coordinate system 208.

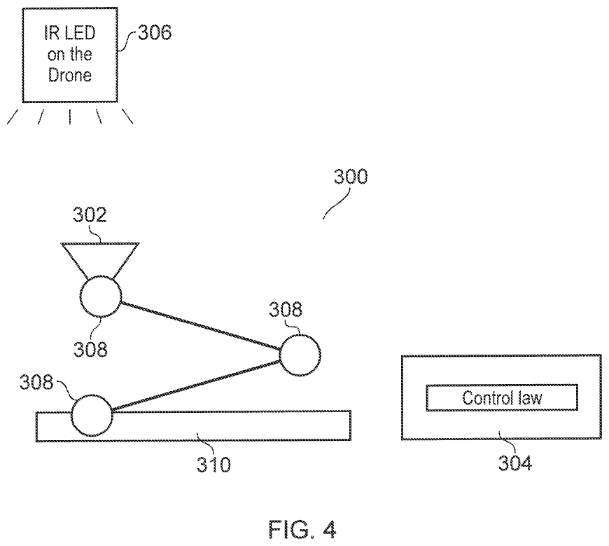

FIG. 4 is an illustrative schematic of the moveable docking station 300 comprising camera 302, servos 308, base 310 and controller 304. The servos 308 confers 3 degrees of freedom such that the moveable docking station 300 can be positioned to assist in docking unmanned vehicle 100. This allows recharge or refuel, data transfer and payload exchange of the unmanned vehicle 100 without the requirement for human operator. The platform 310 may be a static platform, the roof off a moving vehicle, or other platform. The moveable docking station 300 scans for a visual marker 306 situated on an unmanned vehicle by capturing images with camera 302.

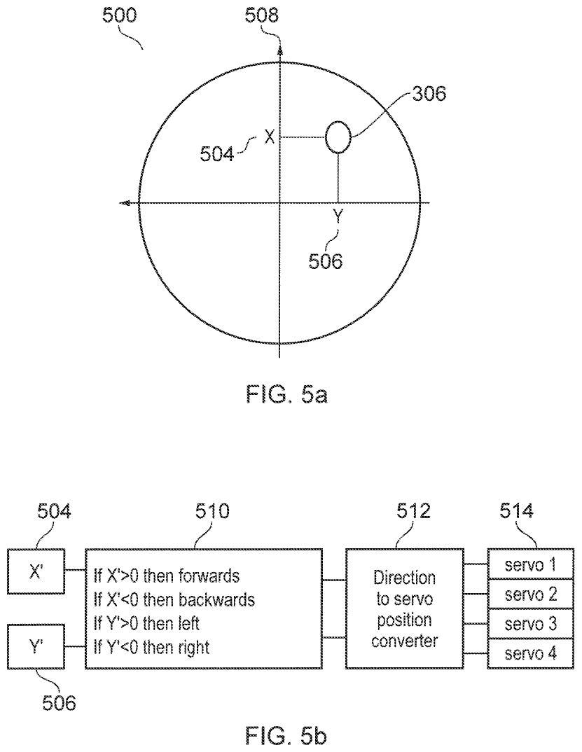

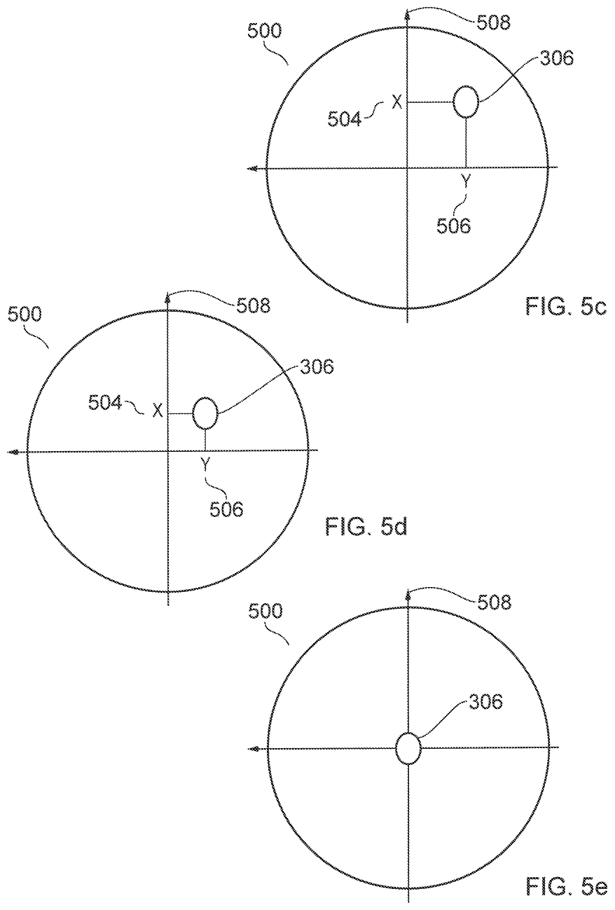

Such an image captured with camera 302 is shown by frame 500 of FIG. 5a. Frame 500 comprises the visual marker 306 of the unmanned vehicle 100, and a relative coordinate system 508 by which the position of visual marker 306 is measured. In this example the position of the visual marker 306 is measured as X and Y coordinates (504 and 506 respectively). The controller 304 subsequently converts the measured X and Y positions (504 and 506 respectively) of the visual marker 306 into a desired direction 510 for the moveable docking station 300 to position itself. The desired direction 510 is then converted 512 into a position 514 for servos 308.

An illustrative example of frames 500 captured by camera 302 measures responsive to the instructions provided by the controller 304 to servos 308 is shown in FIGS. 5c-e. The initial position of the moveable docking station 300 is such that the visual marker 306 situated on the unmanned vehicle 100 is not centred on the coordinate system 508 in frame 500 taken by camera 302. This can be seen by X and Y coordinates (504 and 506 respectively). The controller 304 subsequently converts the measured X and Y positions (504 and 506 respectively) of the visual marker 306 into a desired direction 510 for the moveable docking station 300 to position itself. The desired direction 510 is then converted 512 into servo 308 position 514.

The camera 302 then subsequently captures another frame 500 which depicts the second position of the moveable docking station 300 after the initial instructions provided by controller 304, which is shown in FIG. 3d. The position of the moveable docking station 300 is such that the visual marker 306 situated on the unmanned vehicle 100 is not centred on the coordinate system 508 in frame 500 taken by camera 302. However, the magnitude of the displacement from the centre of the coordinate system 508 is reduced. The controller 304 subsequently converts the measured X and Y positions (504 and 506 respectively) of the visual marker 306 into a desired direction 510 for moveable docking station 300 to position itself. The desired direction 510 is then converted 512 into servo 308 position 514.

The final frame 500 which is captured by camera 302 as shown in FIG. 3e shows the visual marker 306 at the centre of coordinate system 508. The described sequence occurs at a frequency of 200 Hz and if at any time the X or Y position (504 and 506 respectively) of visual marker 306 deviates from the centre of the coordinate system 508 controller 304 will change desired position 214 of servos 308 so as to re-centre onto coordinate system 508.

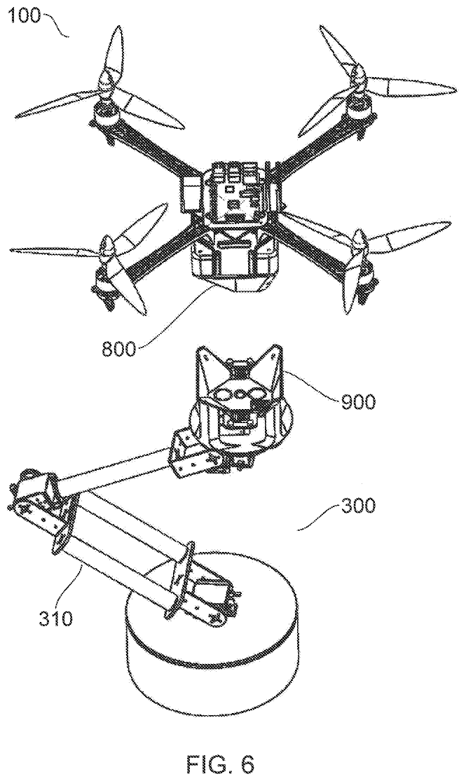

FIG. 6 shows a system comprising unmanned vehicle 100 and a moveable docking station 300. An interface device 800 is mounted on the bottom of the unmanned vehicle 100. The moveable docking station comprises a robotic arm 310 and a complementary interface device 900, which is mounted on the end effector of the robotic arm 310. Interface devices 800 and 900 provide a mechanical link between the moveable docking station 300 and the unmanned vehicle 100 when they are docked together.

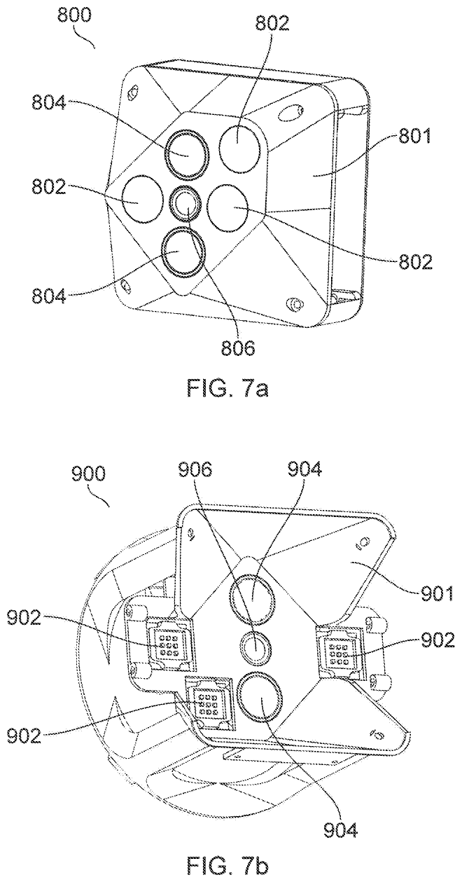

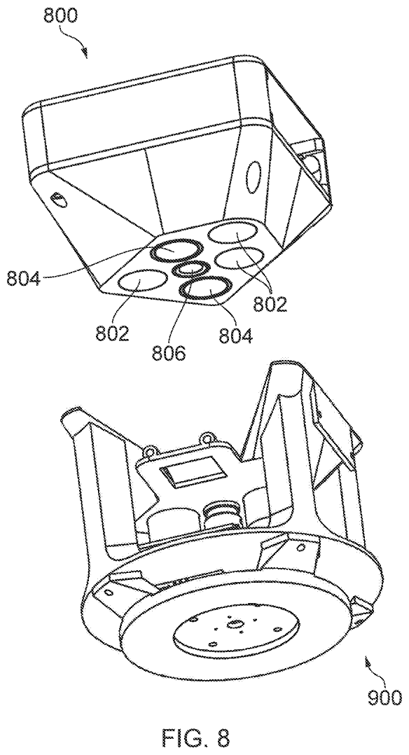

FIG. 7a is an illustrative example of an interface device 800 in accordance with an embodiment of the present disclosure. Interface device 800 comprises an interface surface 801 which is arranged to cooperate or engage with a complementary interface surface 901 on complementary interface device 900 (see FIG. 7b). Three visual markers 802 are arranged on the interface surface 801 in a triangular configuration. The interface surface 801 also comprises two magnetic connection points 804 and an image sensor 806. In this instance the three visual markers 802 are infrared LEDs. However, the skilled person will appreciate that other types of visual marker could be used.

The complementary interface device 900 is illustratively presented in FIG. 8b and comprises complementary interface surface 901 which is arranged to cooperate or engage with a interface surface 801 on interface device 900 (see FIG. 7a). Three visual markers 902 are arranged on the complementary interface surface 901 in a triangular configuration. The complementary interface surface 901 also comprises two magnetic connection points 904, and an image sensor 906. Image sensor 906 is arranged to capture an image frame of the interface surface 801 and depending on the relative position of the visual markers 802 on interface surface 801 the controller of the moveable docking station 300 will instruct it to move into a position more favourable for docking the unmanned vehicle 100 as described in more detail below. The magnetic connection points 904 of complementary interface surface 901 are located in positions corresponding to the location of magnetic connections points 804 of interface surface 801 and are arranged to engage magnetic connections points 804 when interface devices 800 and 900 are in, or near to, a docking configuration.

FIG. 8 shows the interface device 800 and interface device 900 in a position operable to cooperate or engage with each other. Image sensor 806 captures an image of the complementary interface surface 901 of interface device 900 in order to calculate the relative position between the two and adjust its position accordingly. Image sensor 806 captures an image which includes the visual markers 902 of interface surface 901, and will then calculate any adjustment in its position based upon the spatial relationship between the visual markers 902, as described in more detail below,

During the docking procedure a corresponding process is performed by interface device 900, The image sensor 906 also captures an image of the visual markers 802 which are situated on interface surface 801 of interface device 800. Based on the spatial relationship between the visual markers 802, interface device 900 calculates the position and attitude of the unmanned vehicle 100 which interface device 800 is attached to and therefore the relative position between the two interface devices 800 and 900, as described in more detail below,

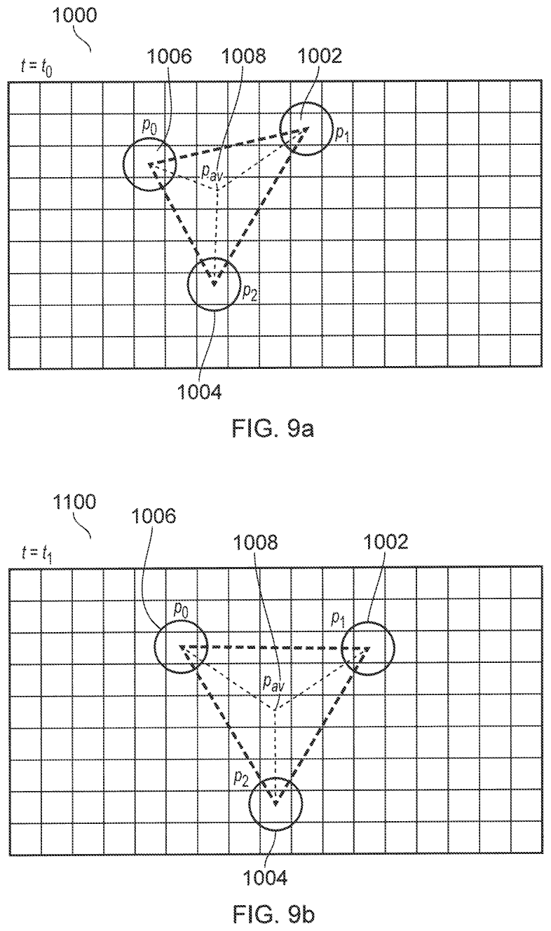

FIG. 9a is an illustrative schematic view of an image 1000 of three visual markers 1002, 1004, and 1006. Image 1000 may be an image captured by an image sensor of an interface device either mounted on an unmanned vehicle or a moveable docking station (referred to as an observing body hereinafter). From the image 1000 the controller of the interface device will be able to calculate the relative position p=(x, y) and attitude of the body which they are attached to, Any measured changes in the position of the detected markers force actuation systems of the observing body to compensate for the detected relative motion. For example, the three visual markers 1002, 1004, and 1006 of FIG. 9a are actually arranged in an equilateral triangle. However, they do not appear as an equilateral triangle due to the position and attitude of the interface device upon which they are mounted. The central point 1008 is not equidistant from the three visual markers 1002, 1004, 1006 nor is it in a position that it expects. Therefore, the controller of the observing body, using computer vision, recognises that the attitude and position of either the target or itself is incorrect.

Upon subsequent compensation of the observing body a further image 1100 is captured by its image sensor as shown in FIG. 9b. Image 1100 shows the central point 1008 in its correct position and the three visual markers 1002, 1004, and 1006 arranged in an equilateral triangle. Therefore, the controller of the observing body, will now recognise that the attitude and position of either the target or itself is correct, One skilled in the art will appreciate that different numbers and arrangements of visual markers can be used and the invention is not limited to three visual markers arranged in an equilateral triangle as described in this embodiment.

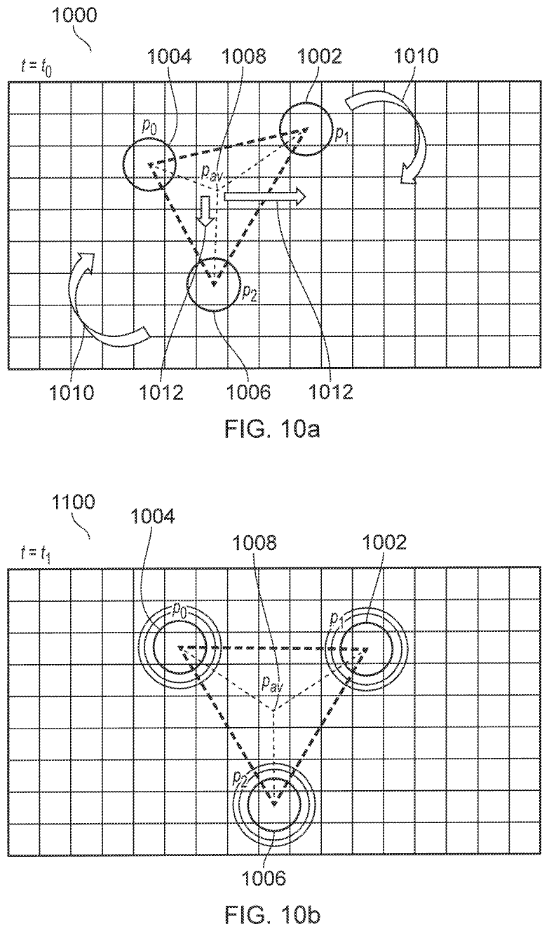

FIG. 10a is a further illustrative schematic view of the image 1000 captured by the observing body's image sensor. Using computer vision the controller of the observer recognises that the central point 1008 is not in the position it expects and therefore instructs the observer to compensate for this, For example the arrows 1010 and 1012 show the observer moving in a rotational and translational motion respectively so as to position the central point 1008 where it expects it to be based on the arrangement of the visual markers 1002, 1004, and 1006 respectively as shown in FIG. 10b. This process is carried out iteratively as the unmanned vehicle approaches the docking station in order to achieve a mutually cooperative docking configuration.

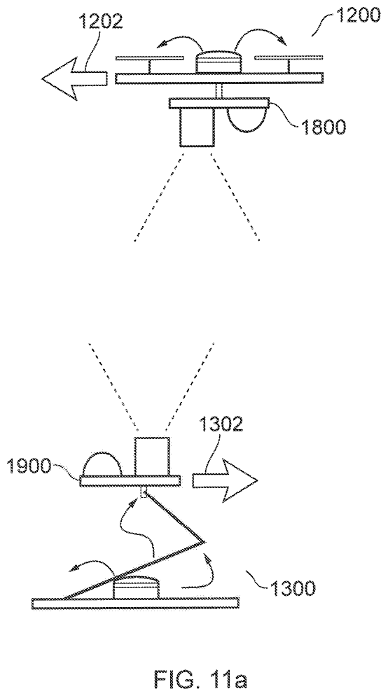

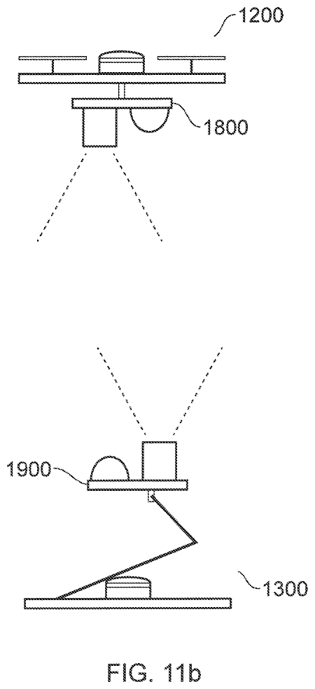

FIG. 11a is an illustrative schematic view showing unmanned vehicle 1200 and moveable docking station 1300 adjusting the positions according to the previously described embodiments. The unmanned vehicle 1200 and moveable docking station 1300 are not in alignment with each other and therefore will not be able to cooperatively dock. The interface devices 1800 and 1900 mounted on the unmanned vehicle 1200 and moveable docking station 1300 respectively adjust the position of the unmanned vehicle 1200 and moveable docking station 1300 accordingly as shown by the arrows 1202 and 1302 respectively.

The interface devices therefore maintains the unmanned vehicle 1200 and moveable docking station 1300 in alignment, as shown in FIG. 11 as the unmanned vehicle 1200 approaches the moveable docking station 1300 in order to achieve docking,

In view of the foregoing description it will be evident to a person skilled in the art that various modifications may be made within the scope of the invention.

For example, instead of using computer vision to determine the attitude of the body being observed, the interface device of the observing body may comprise an inertial measuring unit which adjusts the attitude of the observing body to a predetermined mutually corresponding attitude, for example, a horizontal attitude. Therefore the image sensors only need to correct for relative position which reduces the amount of computing power required.

As used herein any reference to “one embodiment” or “an embodiment” means that a particular element, feature, structure, or characteristic described in connection with the embodiment is included in at least one embodiment. The appearances of the phrase “in one embodiment” or the phrase “in an embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

1. A device for docking an unmanned vehicle with a moveable docking station, the device comprising:
an interface surface configured to cooperatively engage a counterpart interface surface of a counterpart device;
at least one identifying means arranged to be detected by a counterpart device; and
at least one sensor configured to detect an at least one identifying means of a counterpart device.

2. A device according to claim 1, wherein the device comprises a sensor for detecting the attitude of the docking device or a counterpart device.

3. A device according to claim 1 or 2, wherein the device interface surface or counterpart interface surface has a male connector configuration.

4. A device according to claim 3, wherein at least a portion of the device interface surface or counterpart interface surface has a convex surface.

5. A device according to claim 1 or 2, wherein the device interface surface or counterpart interface surface has a female connector configuration.

6. A device according to claim 5, wherein at least a portion of the device interface surface or counterpart interface surface has a concave surface.

7. A device according to any one of claims 1 to 6, wherein the identifying means comprises a visual marker.

8. A device according to any one of claims 1 to 7, wherein the at least one sensor comprises a camera.

9. A device according to claim 8, wherein the camera is an infrared camera.

10. A device according to any one of claims 1 to 9, wherein the identifying means comprises a plurality of visual markers and/or identifying signal emitters.

11. A device according to claim 10, comprising three visual markers and/or identifying signal emitters arranged in a triangular configuration.

12. A device according to any one of claims 1 to 11, wherein the sensor comprises a plurality of sensors such as a plurality of image sensors,

13. A device according to any one of claims 1 to 12, further comprising a coupling to hold the unmanned vehicle in position on the docking station once docking has been achieved.

14. A device according to claim 13, wherein the coupling is electromechanical.

15. A device according to claim 13 or 14, wherein the coupling is electromagnetic permanently magnetic, or semi-permanently magnetic.

16. A device according to any one of claims 13 to 15 wherein the device comprises one or more connectors for performing one or more of the following:
refuelling or recharging the unmanned vehicle;
powering the unmanned vehicle; and
transferring data between the unmanned vehicle and the docking station.

17. A device according to any one of claims 1 to 16, further comprising a transmitter and a receiver for communicating with a counterpart device.

18. A method of docking an unmanned vehicle with a moveable docking station, the method comprising:
performing a cooperative docking procedure;
wherein the cooperative docking procedure comprises each of the unmanned vehicle and docking station capturing the attitude and/or position of the other and, responsive to the captured attitude and/or position, adjusting the respective attitude and/or position of the unmanned vehicle and docking station to a mutually cooperative docking configuration so as to provide docking of the unmanned vehicle with the docking station.

19. A method of docking an unmanned vehicle with a moveable docking station, using a device according to any one of claims 1-17, the method comprising:
performing a cooperative docking procedure;
wherein the cooperative docking procedure comprises each of the unmanned vehicle and docking station capturing the attitude and/or position of the other and, responsive to the captured attitude and/or position, adjusting the respective attitude and/or position of the unmanned vehicle and docking station to a mutually cooperative docking configuration so as to provide docking of the unmanned vehicle with the docking station.

20. A method according to claim 18 or 19, wherein capturing the attitude and/or position comprises at least one of the unmanned vehicle and docking station identifying at least one visual marker located on the other or receiving at least one identifying signal from the other and, responsive to the location of the at least one visual marker or to the identifying signal, calculating a relative position between the unmanned vehicle and docking station.

21. A method according to any one of claims 18 to 20, wherein capturing the attitude and/or position comprises at least one of the unmanned vehicle and docking station receiving an identifying signal and determining its attitude based on the identifying signal.

22. A method according to any one of claims 18 to 21 wherein capturing the attitude and/or position comprises the docking station identifying at least one visual marker on the unmanned vehicle, or the docking station receiving at least one identifying signal from the unmanned vehicle, and, responsive to the location of the at least one visual marker or to the identifying signal, calculating a relative position between the unmanned vehicle and docking station and determining an attitude.

23. A method according to any one of claims 18 to 22, wherein adjusting the respective attitude and/or position of the unmanned vehicle and docking station comprises:
each of the unmanned vehicle and docking station calculating a respective vector in which to move themselves to reduce the relative position between the unmanned vehicle and docking station; and
sending an actuation signal to at least one actuator of each of the unmanned vehicle and docking station respectively to move the unmanned vehicle and docking station along their respective calculated vectors to reduce the relative position between the unmanned vehicle and docking station.

24. A method according to any one of claims 21 to 23, wherein adjusting the respective attitude and/or position of the unmanned vehicle and docking station comprises:
each of the unmanned vehicle and docking station calculating a manoeuvre based on the identifying signal to move themselves to a mutually corresponding attitude; and
sending an actuation signal to at least one actuator of each of the unmanned vehicle and docking station respectively to perform the calculated manoeuvre to move themselves into the mutually corresponding attitude.

25. A method according to claim 24, wherein the mutually corresponding attitude comprises a horizontal attitude.

26. A method according to any one of claims 20 to 25, wherein identifying at least one visual marker or identifying signal comprises capturing an image or location of the at least one visual marker or identifying signal.

27. A method according to claim 26, wherein adjusting the respective attitude and/or position of the unmanned vehicle and docking station comprises:
each of the unmanned vehicle and docking station calculating a respective vector in which to move themselves to move the at least one visual marker or identifying signal towards the centre of the image or captured location; and
sending an actuation signal to at least one actuator of each of the unmanned vehicle and docking station respectively to move the unmanned vehicle and docking station along their respective calculated vectors to move the at least one visual marker or identifying signal towards the centre of the image or captured location.

28. A method according to claim 26 or 27, wherein adjusting the respective attitude and/or position of the unmanned vehicle and docking station comprises performing a manoeuvre such that the at least one visual marker is captured in the image in a certain orientation.

29. A method according to any one of claims 18 to 28, wherein capturing the attitude and/or position of the other is performed as part of an iterative loop.

30. A method according to claim 29, wherein the iterative loop iterates 200 times per second.

31. A method according to any one of claims 18 to 30, wherein the method comprises:
identifying an available docking station
approaching the available docking station;
sending a docking request; and
receiving a signal from an available docking station.

32. A method according to any one of claims 18 to 31, the method further comprising engaging a coupling to hold the unmanned vehicle in position on the docking station once docking has been achieved,

33. A method according to claim 32, the method further comprising:
determining when the unmanned vehicle and docking station are within a threshold proximity range and a threshold relative position range of each other such that docking can be successfully achieved; and
engaging the coupling to complete the cooperative docking procedure.

34. A method according to any one of claims 18 to 33, the method further comprising performing a task selected from one or more of the following once the unmanned vehicle has docked with the docking station:
refuelling or recharging the unmanned vehicle;
transferring data between the unmanned vehicle and the docking station;
diagnosing mechanical or electrical faults;
carrying out maintenance on the unmanned vehicle;
retrieving a payload which has been carried by the unmanned vehicle; and
loading a new payload onto the unmanned vehicle.

35. A kit of parts comprising two or more devices according to any one of claims 1 to 17.

36. An unmanned vehicle comprising a device according to any one of claims 1 to 17.

37. An unmanned vehicle according to claim 36, wherein the unmanned vehicle comprises an unmanned aerial vehicle.

38. A moveable docking station comprising a device according to any one of claims 1 to 17.

39. A moveable docking station according to claim 38, wherein the moveable docking station comprises a robotic arm having an end effector, wherein the end effector comprises a device according to any one of claims 1 to 17.

40. A system comprising an unmanned vehicle according to claim 36 or 37 and a moveable docking station according to claim 38 or 39.
